(19) United States
(12) Patent Application Publication
(10) Pub. No.: US 2007/0161501 A1
(43) Pub. Date: Jul. 12, 2007

(54) Method for making carbon nanotube-supported platinum alloy electrocatalysts

(75) Inventors: Chun-Ching Chien, Taipei City (TW); King-Tsai Jeng, Longtan Township (TW); Shean-Du Chiou, Pingjhen City (TW); Su-Hsine Lin, Longtan Township (TW); Wan-Min Huang, Longtan Township (TW); Ning-Yih Hsu, Keelung City (TW)

Correspondence Address: TROXELL LAW OFFICE PLLC, SUITE 1404, 5205 LEESBURG PIKE, FALLS CHURCH, VA, 22041, US

(73) Assignee: Atomic Energy Council - Institute of Nuclear Energy Research

(21) Appl. No.: 11/328,118

(22) Filed: Jan. 10, 2006

(51) Int. Cl. H01M 4/88

(52) U.S. Cl. 502/101

(57) ABSTRACT

In the present invention, platinum and alloying metal precursor ions are reduced to platinum alloy particles using specifically prepared reducing agents, under controlled reaction temperature and pH conditions, with uniform dispersion and high uniformity in nano-scale sizes adhered onto carbon nanotubes; besides, the compositions of prepared Pt alloy electrocatalysts can be put under control as desired.

### FIELD OF THE INVENTION

The present invention relates to a method for making platinum alloy electrocatalysts on new carbon supports; more specifically, relates to, through chemical reduction reactions, reducing platinum alloy complex ions to nano-scale platinum alloy particles cohered onto carbon nanotube (CNT) surfaces to obtain CNT-supported platinum alloy electrocatalysts.

### DESCRIPTION OF THE RELATED ARTS

Direct methanol fuel cells (DMFC) and proton exchange membrane fuel cells (PEMFC) are membrane fuel cells which use proton exchange membranes, e.g., Nafion membranes manufactured by DuPont Co., USA, as solid polymer electrolytes, so as to make the devices compact. These advanced power devices comprise advantages of high energy density, high power transformation, simple structure, long runtime and easy carrying, which can be used as substitutes to conventional electrochemical batteries for uses in electric vehicles, hand-held computers mobile phones and other commercial electronic products. The prior arts of DMFC and PEMFC generally use carbon black-supported platinum (Pt/C) as the cathode catalyst to improve the reduction reaction of the oxygen or the air; and use carbon black-supported Pt alloy, such as Pt-Ru(ruthenium)/C, as the anode catalyst to improve the oxidization of fuel (such as hydrogen gas and methanol solutions). The use of a Pt alloy instead of a pure Pt as an anode catalyst is to prevent the catalyst from poisoning by carbon monoxide or other intermediate products from the methanol oxidization; and this is a key technology to the success of membrane fuel cells. The binary component Pt-Ru alloy is especially the most used anode catalyst at present; and, other multi-component alloys, such as Pt-Ru-Ir (iridium) and Pt-Ru-Ir-Rh (rhodium), have catched the eyes of the researchers in this field, which are expected to be more effective than the Pt-Ru alloy as anode catalysts and have better capabilities on poisoning resistances.

Concerning the preparation of platinum alloy electrocatalysts, in the prior arts conductive carbon blacks (such as the Vulcan XC72 by Cabot Co. and the Shawinigan by Chevron Co.) are commonly used as carriers and their preparation methods are detailed in some patents, which include: U.S. Pat. No. 5316990, “Catalyst material”, U.S. Pat. No. 5489563, “Platinum alloy catalyst for fuel cells and method of its production”, U.S. Pat. No. 5939220, “Catalyst” and U.S. Pat. No. 6007934, “Co-tolerant anode catalyst for PEM fuel cells and a process for its preparation”. However, the advantages of Pt alloy catalysts strongly depend on suitable grain sizes, good particle dispersion on carbon supports and, in particular, proper electrocatalyst compositions. For example, an atomic ratio close to Pt:Ru=1:1 for a Pt-Ru alloy electrocatalyst promises a good performance, which is well known to those who are familiar with the arts in this field.

Although the prior arts of conductive carbon black-supported platinum alloy electrocatalysts have exhibited moderate performances in membrane fuel cells so far, they still require significant improvements so as to meet the needs for product commercialization. The use of a new generation of catalyst supports, such as carbon nanotubes, with much better distinctive properties to prepare Pt alloy electrocatalysts with enhanced performances is considered to be a feasible approach to achieve this goal.

At present, reductive preparation of a CNT-supported, single-component Pt electrocatalyst (Pt/CNT) using ethylene glycol (EG) as the sole reducing agent seems to be the most popular method. However, in the preparation of binary and multi-component CNT-supported Pt alloy electrocatalysts, difficulties arise that the platinum ions and its alloying metal ions cannot be reduced simultaneously at the same pH value or at a competitive specific reduction rates using EG alone. These are mainly due to totally different reduction conditions for different metal ions. In addition, EG is a fairly weak reducing agent. As a result, CNT-supported Pt alloy electrocatalysts cannot be successfully prepared using the same procedure with satisfactory results as that for Pt/CNT, particularly in obtaining the desired electrocatalyst compositions. Hence, the prior arts do not fulfill users' requests on practical uses in membrane fuel cells.

### Summary of the invention

The main purpose of the present invention is to obtain carbon nanotube-supported platinum alloy electrocatalysts with high uniformities to the grain sizes of particles in nano-scales, uniform dispersion of the particles and controls to the compositions of the platinum alloy electrocatalysts obtained.

To achieve the above purpose, the present invention is a method for making carbon nanotube-supported platinum alloy electrocatalysts, whose preparation procedure comprises: a) pouring a strong acid-oxidized CNT powder into a first ethylene glycol solution; b) obtaining a CNT paste from the first ethylene glycol solution through an ultrasound sonicating and a high-speed stirring; c) dissolving a platinum (Pt) salt and at least an alloying noble metal salt into a second ethylene glycol solution, then adding a modification additive into the second ethylene glycol solution, and then adding the second ethylene glycol solution to the CNT paste; d) adjusting a pH value of the mixed ethylene glycol solution using an alkaline aqueous solution; e) conducting a high-speed stirring to the mixed ethylene glycol solution, and heating the ethylene glycol solution to process a reduction reaction of Pt alloy ions on CNT surfaces; f) filtering the CNT out from the ethylene glycol solution after the reduction reaction, and washing the CNT with a deionized water; and g) drying the CNT to obtain a Pt alloy electrocatalyst supported on the CNT. Accordingly, a novel method for making carbon nanotube-supported platinum alloy electrocatalysts is established.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a view showing a flow chart according to a preferred embodiment of the present invention;

FIG. 2 is a view showing curves of current to potential in a methanol oxidization applied with a Pt-Ru/CNT and a Pt-Ru-Ir/CNT according to the preferred embodiment of the present invention and applied with a Pt-Ru/C of a prior art; and

FIG. 3 is a view showing working curves of voltage to current density and those of power density to current density for a DMFC whose anode catalyst is a Pt-Ru/CNT according to the present invention or is a Pt-Ru/C of the prior art.

### DESCRIPTION OF THE PREFERRED EMBODIMENTS

The following descriptions of the preferred embodiments are provided to understand the features and the structures of the present invention.

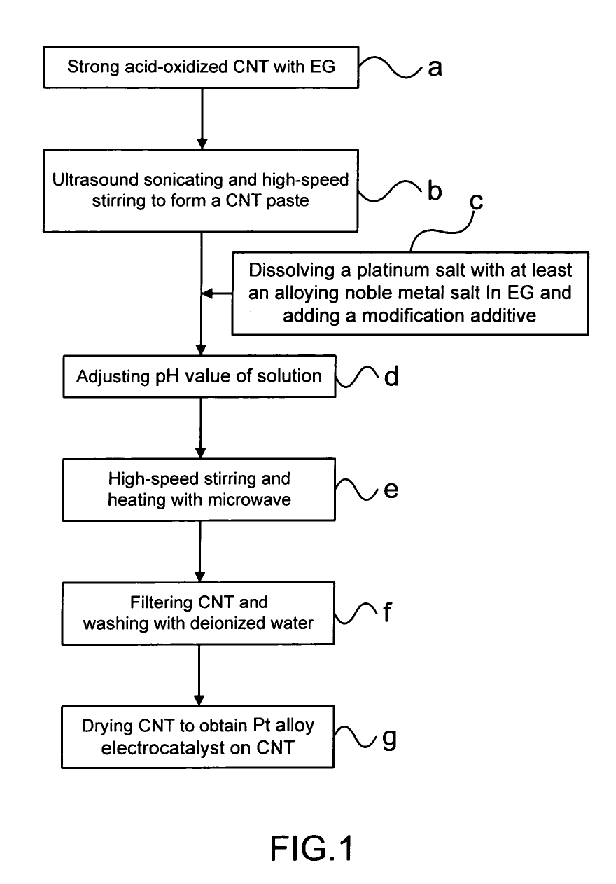

Please refer to FIG. 1, which is a view showing a flow chart according to a preferred embodiment of the present invention. As shown in the figure, the present invention relates to a method for making carbon nanotube-supported platinum alloy electrocatalysts, comprising the following steps:

Step (a): Pouring a powder of a strong acid-oxidized carbon nanotube (CNT) into a first ethylene glycol solution. The strong acid can be HNO₃ or a mixture of HNO₃ and H₂SO₄. Therein, the CNT is a single-wall CNT, a multi-wall CNT, a carbon nanohorn or a CNT of any other shape; the CNT comprise s a few exchange groups, through oxidization reactions with the strong acid, on its surfaces, such as —COOH, —OH and —C═O, helping cohesion exchanges of metal ions and formation of catalyst nuclei; And, the first ethylene glycol solution is used as a main dispersant and reducing agent.

Step (b): Obtaining a CNT paste having ethylene glycol from the first ethylene glycol solution through an ultrasound sonicating for 10 min (minute) and a high-speed stirring for 5 to 30 min.

Step (c): Dissolving a platinum (Pt) salt and at least an alloying noble metal salt into a second ethylene glycol solution; then, adding a modification additive into the second ethylene glycol solution; and, then, adding the second ethylene glycol solution to the CNT paste. Therein, the Pt salt is H₂PtCl₆, PtCl₄, Pt(NO₃)₂, etc.; the noble metal salt is a ruthenium (Ru) salt, an iridium (Ir) salt, a palladium (Pd) salt, a rhodium (Rh) salt or an osmium (Os) salt, etc.; the noble metal salt of a ruthenium salt can be RuCl₃; the noble metal salt of an iridium salt can be IrCl₃; and, the modification additive can be a sulfite salt of NaHSO₃, used as an auxiliary dispersant and reducing agent.

Step (d): Adjusting a pH value of the mixed ethylene glycol solution using an alkaline aqueous solution. Therein, the mixed ethylene glycol solution after the adjusting comprises a pH value between 0 and 4 and a water content between 0 and 10 vol %; the alkaline aqueous solution is a Ca(OH)₂ solution, a NaOH solution, a KOH solution or a Mg(OH)₂ solution, etc.; the pH value of the mixed ethylene glycol solution is adjusted to move the zeta potential on the surface of the CNT to be close to an isoelectric point (IEP). The IEP is a special point where the zeta potential is equal to zero and no net charges exist on the CNT surfaces; and thus, all metal ions or complex ions around there have almost the same cohesion capabilities to CNT surfaces. By doing so, the composition of the obtained Pt alloy electrocatalyst is under control. That is to say, a required composition of the Pt alloy electrocatalyst can be obtained through a control of the metal ion concentrations in the second ethylene glycol solution. On the other hand, by properly controlling the water content of the mixed ethylene glycol solution, an aggregated growing of Pt alloy catalyst particle can be avoided, whose grain size is mainly limited between 3 and 5 nm (nanometer), and so a better performance on using the Pt alloy catalyst is obtained.

Step (e): Processing a high-speed stirring to the mixed ethylene glycol solution for 30 to 40 min; and, then, heating the ethylene glycol solution to process a reduction reaction of Pt alloy ions. Therein, the heating comprises a temperature between 110 and 150° C. (Celsius degree); if the heating is done through microwave, the heating comprises a processing time between 10 and 120 min; if the heating is done through other conventional way, such as done with an electrical heating plate, the heating comprises a processing time between 1 and 2 hr (hour); a heating done through microwave comprises an effect of a homogeneous and fast heating, so that the reduction reaction time of the Pt alloy catalyst is shortened and the Pt alloy catalyst is formed homogeneously and is well dispersed; and, the auxiliary dispersant and reducing agent is used to ameliorate the main dispersant and reducing agent, i.e., EG, so that, as being functioned under a low pH value, the reduction is further improved to reduce function time, and the complexation and the dispersion of the metal ions is improved to control the formation of the Pt alloy electrocatalyst particles.

Step (f) After finishing the reduction reaction, filtering the CNT out from the ethylene glycol solution; and, then, washing the CNT with deionized water.

Step (g): Drying the CNT in an oven to obtain a Pt alloy electrocatalyst supported on the CNT. Therein, the oven comprises a temperature between 100 and 105° C.; the obtained Pt alloy electrocatalyst comprises particles with high uniformity on grain size and with high dispersion on CNT; the Pt alloy electrocatalyst supported on the CNT can be used as an anode catalyst in a Direct Methanol Fuel Cell (DMFC) or a Proton Exchange Membrane Fuel Cell (PEMFC); and, the obtained CNT-supported electrocatalyst comprises a Pt alloy content between 5 and 80 wt % (weight percentage).

The followings are detailed descriptions of some preferred embodiments and some applications according to the present invention:

### Example 1

Preparing a binary component Pt alloy electrocatalyst supported on a CNT (Pt-Ru/CNT)

Example 1 is to prepare a 20 wt % Pt-10 wt % Ru/CNT having an atomic ratio of ca. Pt:Ru=1:1 comprising the following steps:

Step (a): Pouring a 1.65 g (gram) of powder of a strong acid-oxidized CNT into a 50 ml (milliliter) of a first ethylene glycol solution.

Step (b): Obtaining a CNT paste having ethylene glycol from the first ethylene glycol solution through an ultrasound sonicating for 10 min and a high-speed stirring for 30 min.

Step (c): Dissolving a 1.264 g of H₂PtCl₆.6H₂O and a 0.506 g of RuCl₃ into a 10 ml of a second ethylene glycol solution; then, adding a 1 ml of 1 M (mole) NaHSO₃ solution into the second ethylene glycol solution; and, then, adding the second ethylene glycol solution to the CNT paste.

Step (d): Adjusting a pH value of the mixed ethylene glycol solution to 2 with a 2N (moles) Ca(OH)₂ solution.

Step (e): Processing a 30 min of a high-speed stirring to the mixed ethylene glycol solution; and, then, heating the mixed ethylene glycol solution at 120° C. through a microwave to process a reduction reaction for 60 min.

Step (f): After finishing the reduction reaction, filtering the CNT out from the ethylene glycol solution; and, then, washing the CNT with deionized water.

And, Step (g) Drying the CNT by using an oven to obtain a binary component Pt alloy electrocatalyst supported on a CNT (Pt-Ru/CNT).

Here, an inductively coupled plasma ICP) spectroscope is used to analyze the amount of residual metal ions in the filtrate and the wash wastewater, where the effect of the metal reduction is figured out as greater than 95% and the Pt alloy catalyst comprises a composition of Pt:Ru=1:0.93, which is very close to a preferred value of 1:1.

By observing with a transmission electron microscope (TEM) under 200 kV (kilovolt) and a magnification of 200 k (k=1000), it is found that the grain size of the catalyst is between 2 and 5 nm, which is ideal to be an anode catalyst for a DMFC or a PEMFC, having an average grain size of 3.3 nm.

### Example 2

Preparing a multi-component Pt alloy electrocatalyst supported on a CNT (Pt-Ru-Ir/CNT)

Example 2 is to prepare a 20 wt % Pt-10 wt % Ru-5 wt % Ir/CNT having an atomic ratio of ca. Pt:Ru:Ir=1:1:0.25, comprising the following steps:

Step (a): Pouring a 0.8 g of powder of an acid-oxidized CNT into a 50 ml of a first ethylene glycol solution.

Step (b): Obtaining a CNT paste having ethylene glycol from the first ethylene glycol solution through an ultrasound sonicating for 10min and a high-speed stirring for 30 min.

Step (c): Dissolving a 0.60 g of H₂PtCl₆.6H₂O, a 0.25 g of RuCl₃ and a 0.10 g of IrCl₃.3H₂O into a 10 ml of a second ethylene glycol solution; then, adding a 1 ml of 10% NaHSO₃ solution into the second ethylene glycol solution; and, then, adding the second ethylene glycol solution to the CNT paste.

Step (d): Adjusting a pH value of the mixed ethylene glycol solution to 4 with a 1.5 ml of 4N Ca(OH)₂ solution.

Step (e): Processing a 30 min of a high-speed stirring to the mixed ethylene glycol solution; and, then, heating the mixed ethylene glycol solution at 130° C. through a microwave to process a reduction reaction for 120 min.

Step (f): After finishing the reduction reaction, filtering the CNT out from the ethylene glycol solution; and, then, washing the CNT with deionized water.

And, Step (g): Drying the CNT by using an oven to obtain a multi-component Pt alloy electrocatalyst supported on a CNT (Pt-Ru-Ir/CNT).

Here, an ICP spectroscope is used to analyze the amount of residual metal ions in the filtrate and the wash waste water, where the effect of the metal reduction is figured out as greater than 95% and the Pt alloy catalyst comprises a composition of Pt:Ru:Ir=1:0.94:0.24, which is very close to a preferred value of 1:1:0.25. On the other hand, the Ca(OH)₂ solution in step (d) can be replaced with another alkaline aqueous solution, such as a NaOH solution, a KOH solution or a Mg(OH)₂ solution, etc.

By observing with a TEM microscope under 200 kV and a magnification of 200 k (k=1000), it is found that the grain size of the catalyst is between 2 and 6 nm, which is ideal to be an anode catalyst for a DMFC or a PEMFC, having an average grain size of 3.5 nm.

### Example 3

Testing the prepared Pt alloy electrocatalysts in a methanol oxidization using an electrochemical linear-sweep method

In Example 3, the obtained Pt-Ru/CNT or Pt-Ru-Ir/CNT is respectively fixed on the surface of a glassy carbon anode, having an surface area of 0.196 cm², using a 5 wt % of Nafion solution, where the support capacity of the surface of glassy carbon anode is 2.5 mg/cm² (miligram per square centimeter). The oxidization proceeds in a 0.5M H₂SO₄ aqueous solution containing 1M methanol using a linear sweep speed of 10 mV/sec (millivolt per second).

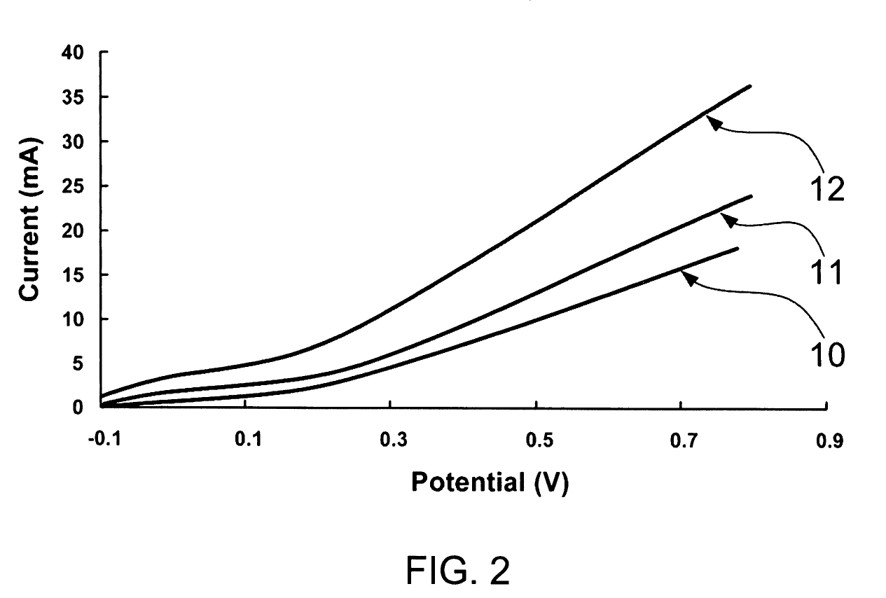

Please refer to FIG. 2, which is a view showing curves of current to potential in a methanol oxidation applied with a Pt-Ru/CNT and a Pt-Ru-Ir/CNT according to the preferred embodiment of the present invention and applied with a Pt-Ru/C of a prior art. As shown in the figure, a comparison is made concerning a methanol oxidization respectively done with the obtained Pt-Ru/CNT and the obtained Pt-Ru-Ir/CNT according to the present invention and with a commercial Pt-Ru/C (a Pt-Ru catalyst supported on carbon black) made by Johnson-Matthey. In the figure, a curve for the Pt-Ru/CNT 10, a curve for the Pt-Ru-Ir/CNT 11 and a curve for the Pt-Ru/C are shown; and it is found that the prepared Pt alloy electrocatalysts (Pt-Ru/CNT 10 and Pt-Ru-Ir/CNT 11) according to the present invention have better performances.

### Example 4

Applying the prepared Pt-Ru/CNT to a DMFC as an anode catalyst

When the prepared catalyst of Pt-Ru/CNT according to the present invention is applied to a DMFC, an anode catalyst is obtained with the prepared Pt-Ru/CNT according to the present invention while mixed with a certain amount of a 5 wt % Nafion solution to be smeared on a wet-proof carbon cloth having a support capacity of 4 mg/cm². A cathode catalyst is obtained with a commercial gas diffusion electrode supported on a carbon black having a support capacity of 4 mg/cm². The two electrodes and a proton exchange membrane (Nafion 117) are hot-pressed to obtain a Membrane Electrode Assembly (MEA). And a single-cell PEMFC is fabricated with the MEA together with two graphite plates.

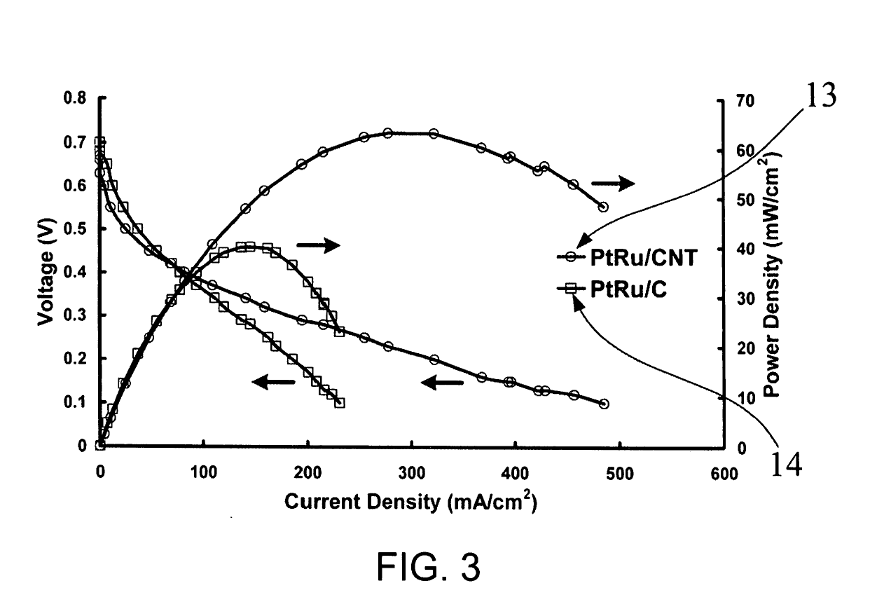

Please refer to FIG. 3, which is a view showing working curves of voltage to current density and those of power density to current density for a DMFC whose anode catalyst is a Pt-Ru/CNT according to the present invention or is a Pt-Ru/C of the prior art. As shown in the figure, a comparison is made concerning an anode catalyst respectively made of the obtained Pt-Ru/CNT according to the present invention and of a commercial Pt-Ru/C made by E-TEK. In the figure, two curves for the Pt-Ru/CNT 13 as an anode catalyst and two curves for the Pt-Ru/C 14 as an anode catalyst are shown; and, it is found that the Pt alloy electrocatalyst (Pt-Ru/CNT 13) prepared according to the present invention has a better performance.

To sum up, the present invention relates to a method for making carbon nanotube-supported platinum alloy electrocatalysts, where carbon nanotube-supported platinum alloy electrocatalysts are obtained with high uniformities to the grain sizes of particles and uniform dispersion of the particles, and with controls to the compositions of the obtained platinum alloy electrocatalysts.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method for making carbon nanotube-supported platinum alloy electrocatalysts, comprising:
Step (a): Pouring a powder of a strong acid-oxidized carbon nanotube (CNT) into a first ethylene glycol solution;
Step (b): Obtaining a carbon nanotube paste having ethylene glycol from said first ethylene glycol solution through an ultrasound sonicating and a stirring;
Step (c): Dissolving a platinum (Pt) salt and at least an alloying noble metal salt into a second ethylene glycol solution, then adding a modification additive into said second ethylene glycol solution, and then adding said second ethylene glycol solution to said carbon nanotube paste;
Step (d): Adjusting a pH value of said mixed ethylene glycol solution with an alkaline aqueous solution;
Step (e): Processing a high-speed stirring to said mixed ethylene glycol solution, and heating said mixed ethylene glycol solution to process a reduction reaction;
Step (f): After finishing said reduction reaction, filtering said CNT out from said mixed ethylene glycol solution, and washing said CNT with deionized water; and
Step (g): Drying said CNT to obtain a platinum alloy electrocatalyst supported on said CNT.

2. The method according to claim 1, wherein said a modification additive is a sulfite salt aqueous solution.

3. The method according to claim 2, wherein said a sulfite salt aqueous solution is selected from a group consisting of, preferably a NaHSO₃ solution and a Na₂SO₃ solution.

4. The method according to claim 1, wherein said an alkaline aqueous solution is selected from a group consisting of, preferably a Ca(OH)₂ solution, a NaOH solution, a KOH solution and a Mg(OH)₂ solution.

5. The method according to claim 1, wherein said pH value of said mixed ethylene glycol solution after said adjusting is located preferably between 0 and 4.

6. The method according to claim 1, wherein said heating is operated in a way selected from a group consisting of preferably using a microwave, using a heating mantle and using an electrical heating plate.

7. The method according to claim 1, wherein said second ethylene glycol solution after said adjusting comprises a water content preferably between 0 vol % and 10 vol %.

8. The method according to claim 1, wherein said heating is done under a temperature preferably between 110 degrees Celsius and 150 degrees Celsius.

9. The methods according to claim 1, wherein said platinum alloy electrocatalyst comprises a platinum alloy content preferably between 5 wt % (weight percentage) and 80 wt %.

10. The method according to claim 1, wherein said CNT comprises a structure selected from a group consisting of preferably a single-wall CNT, a multi-wall CNT and a carbon nanohorn.

11. The method according to claim 1, wherein said a Pt salt is selected from a group of Pt-containing salts, consisting of preferably PtCl₄, H₂PtCl₆ and Pt(NO₃)₂.

12. The method according to claim 1, wherein said an alloying noble metal salt is selected from a group consisting of preferably ruthenium (Ru) salt, iridium (Ir) salt, palladium (Pd) salt, rhodium (Rh) salt and osmium (Os) salt.

13. The method according to claim 12, wherein said ruthenium salt is a Ru-containing salt, preferably RuCl₃.

14. The method according to claim 12, wherein said iridium salt is an Ir-containing salt, preferably IrCl₃.

15. The method according to claim 12, wherein said palladium salt is a Pd-containing salt, preferably PdCl₂.

16. The method according to claim 12, wherein said rhodium salt is a Rh-containing salt, preferably RhCl₃.

17. The method according to claim 12, wherein said osmium salt is an Os-containing salt, preferably OSCl₃.

18. The method according to claim 1, wherein said drying comprises a temperature preferably between 100 degrees Celsius and 105 degrees Celsius.

19. The method according to claim 1, wherein said platinum alloy electrocatalyst on said CNT comprises a weight percentage ratio of Pt to Ru, preferably equals to 20 to 10 with an atomic ratio of Pt to Ru equals to 1 to 1.

20. The method according to claim 1, wherein said platinum alloy electrocatalyst on said CNT comprises a weight percentage ratio of Pt to Ru to Ir, preferably equals to 20 to 10 to 5 with an atomic ratio of Pt to Ru to Ir equals to 1 to 1 to 0.25.
